(19) United States
(12) Patent Application Publication
(10) Pub. No.: US 2011/0320667 A1
(43) Pub. Date: Dec. 29, 2011

(54) ELECTRONIC DEVICE WITH NETWORK INTERFACE CARD

(75) Inventors: PO-WEN CHIU, Tu-Cheng (TW); ZHAN-YANG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/895,217

(22) Filed: Sep. 30, 2010

(30) Foreign Application Priority Data
Jun. 29, 2010 (CN) 201010212564.3

(51) Int. Cl. G06F 13/00

(52) U.S. Cl. 710/301

(57) ABSTRACT

An electronic device includes a first motherboard and a network interface card (NIC). A cutout is defined in the first motherboard. The NIC is located in the cutout of the first motherboard and positioned substantially parallel to the motherboard. The NIC includes a network socket is capable of receiving a network cable, and a printed circuit board (PCB). The PCB includes a first edge, a second edge, and a third edge. The network socket is located in the first edge. The second edge is substantially perpendicular to the first edge. A side connector is located on the second edge. The second edge is capable of being vertically connected to a second motherboard. The third edge substantially parallels to the first edge. A back connector is located on the third edge, that is plugged into the first motherboard in parallel.

### BACKGROUND

1. Technical Field

The present disclosure relates to electronic devices, especially to an electronic device having a network interface card.

2. Description of Related Art

A network interface card (NIC) is a hardware device that is an interface to a computer network and allows a network-capable device to access that network. A network card typically has a RJ45 or BNC socket where the network cable is connected and a few LEDs to inform the user of whether the network is active and whether or not there is data being transmitted on it. The network interface cards can be plugged into a bus of a motherboard. However, a receiving direction of the network interface card is fixed, so the network cable must plug into the network interface card in a fixed direction.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an electronic device according to an embodiment.

FIG. 2 is an exploded view of a network interface card of FIG. 1.

FIG. 3 is an assembled view of FIG. 2.

FIG. 4 is an assembled view of FIG. 1.

FIG. 5 is a working state of the network interface card of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

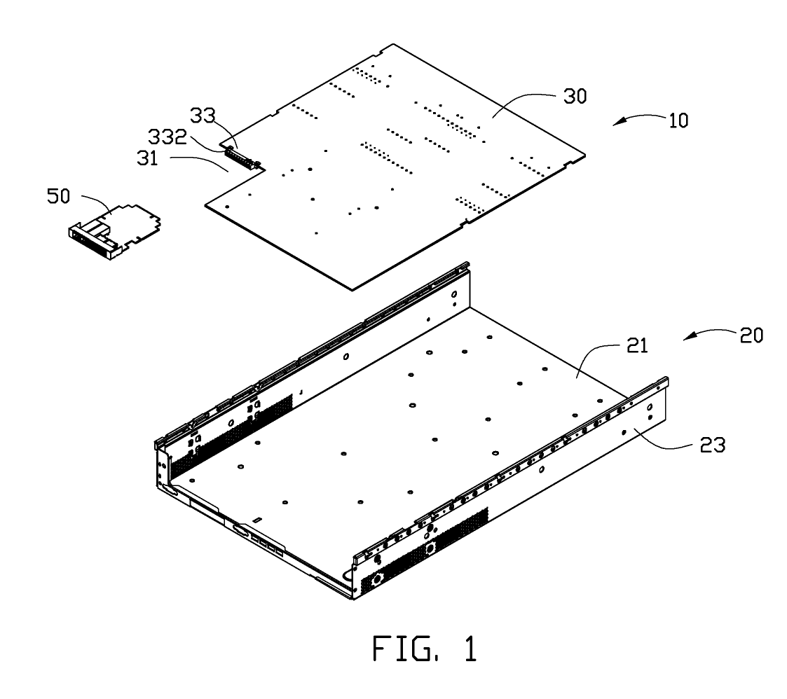

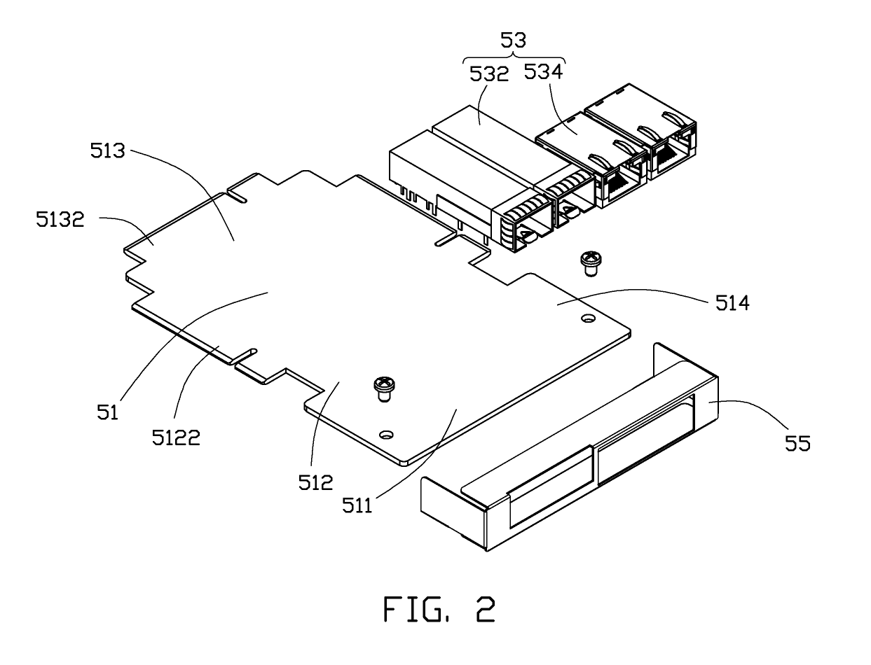

Referring to FIGS. 1 and 2, an electronic device 10 in accordance with an embodiment includes a chassis 20, a motherboard 30 and a network interface card (NIC) 50. The electronic device 10 may be a computer, a server, etc.

The chassis 20 includes a bottom wall 21 and two opposite sidewalls 23 substantially perpendicular to the bottom wall 21. The chassis 20 has a U-shaped cross section.

The motherboard 30 may be fixed to the chassis 20 in a stationary position. A rectangular cutout 31 is defined in the motherboard 30 for receiving the NIC 50. In one embodiment, the cutout 31 is defined in a corner of the motherboard 30. The motherboard 30 includes an engaging edge 33. An expansion socket 332 is located in the engaging edge 33 for receiving the NIC 50. The expansion socket 332 can receive the NIC 50 in a direction substantially parallel to the motherboard 30. When the motherboard 30 is fixed to the chassis 20, the engaging edge 33 is substantially perpendicular to the sidewalls 23 of the chassis 20.

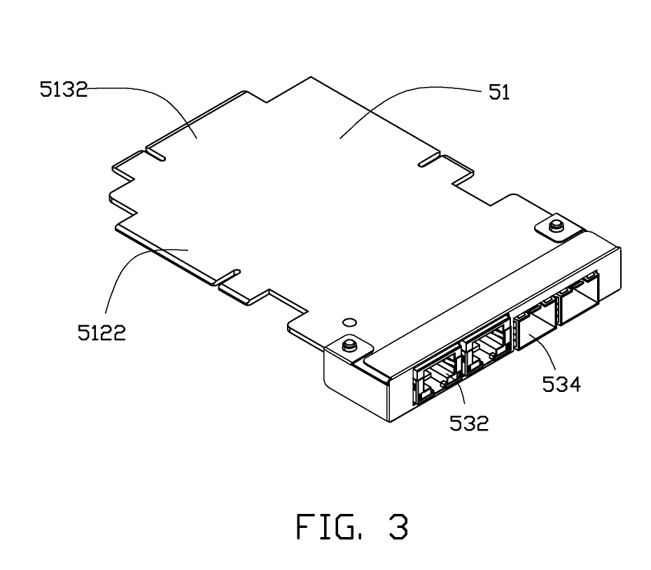

Referring to FIG. 2 and FIG. 3, the NIC 50 includes a printed circuit board (PCB) 51, a plurality of network sockets 53 for receiving network cables, and an electro magnetic interference (EMI) bracket 55 surrounding the plurality of network sockets 53. The PCB 51 is substantially rectangular. The PCB 51 includes a first edge 511, a second edge 512, a third edge 513, and a fourth edge 514. The first edge 511 is parallel to the third edge 513 and is perpendicular to the second edge 512 and the fourth edge 514. The plurality of network sockets 53 and the EMI bracket 55 are fixed to the first edge 511. A back connector 5132 extends from the third edge 513 for plugging into the expansion socket 332. An alternative side connector 5122 extends from the second edge 512.

In one embodiment, the NIC 50 can be used when either one of the back connector 5132 and the side connector 5122 is connected to the motherboard 30 at one point. The back connector 5132 and the side connector 5122 may be the same type, such as PCI connectors. The plurality of network sockets 53 may include two RJ45 sockets 532 and two Bayonet Neill-Concelman (BNC) sockets 534.

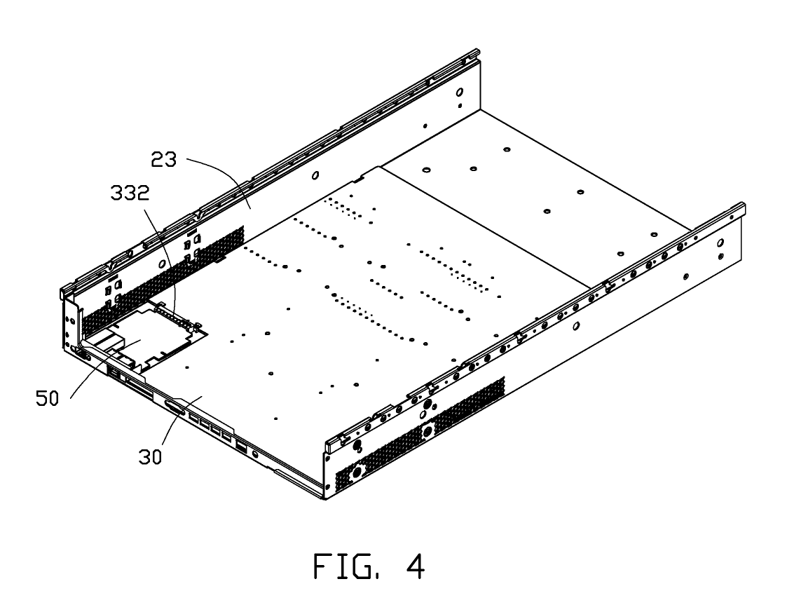

Referring to FIG. 4, the motherboard 30 is fixed to the chassis 20. The NIC 50 is connected to the motherboard 30 with the back connector 5132 being plugged into the expansion socket 332. The NIC 50 is located parallel to the motherboard 30. For facilitating manufacturing the motherboard 30, the rectangular cutout 31 may be defined in a corner. The NIC 50 may be positioned adjacent to one of the two sidewalls 23. The first edge 511 may be substantially perpendicular to the two sidewalls 23.

In one embodiment, since the NIC 50 is positioned parallel to the motherboard 30, space occupied by NIC 50 in the chassis 20 is reduced. The chassis 20 then can receive more electronic components.

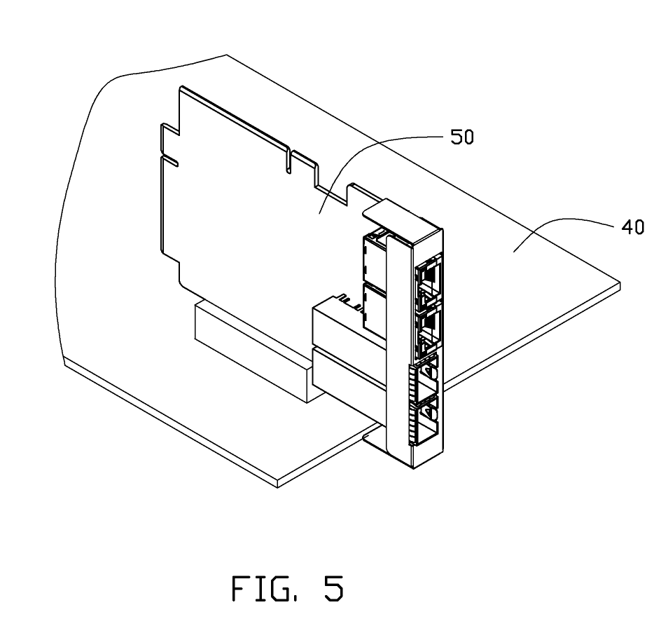

Referring to FIG. 5, the NIC 50 can also be vertically plugged into a motherboard 40 through the side connector 5122. In this way, the NIC 50 can be plugged into a motherboard in two alternative ways according to requirement of a receiving direction of the NIC 50.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
a first motherboard, a cutout defined in the first motherboard; and
a network interface card (NIC) located in the cutout of the first motherboard and positioned substantially parallel to the motherboard, the NIC comprising:
a network socket being capable of receiving a network cable; and
a printed circuit board (PCB), the PCB comprising:
a first edge, the network socket located in the first edge;
a second edge, substantially perpendicular to the first edge, and a side connector located on the second edge, and the second edge being capable of being vertically connected to a second motherboard; and
a third edge, substantially parallel to the first edge, a back connector, located on the third edge, that is plugged into the first motherboard in parallel.

2. The electronic device of claim 1, wherein the network socket is a RJ45 socket.

3. The electronic device of claim 1, wherein the back connector and the side connector are the same type.

4. The electronic device of claim 1, wherein the back connector and the side connector are PCI connectors.

5. The electronic device of claim 1 further comprising a chassis, wherein the first motherboard and the NIC are received in the chassis.

6. The electronic device of claim 5, wherein the chassis comprises a bottom wall and two opposite side walls substantially perpendicular to the bottom wall, and the NIC is positioned adjacent to one of the two opposite side walls.

7. The electronic device of claim 6, wherein the first edge is substantially perpendicular to the two opposite side walls.

8. A network interface card (NIC) being capable of communicating to a first motherboard or a second motherboard, the NIC comprising:
a network socket being capable of receiving a network cable; and
a printed circuit board (PCB), the PCB comprising:
a first edge, the network socket located in the first edge;
a second edge substantially perpendicular to the first edge, and a side connector located on the second edge and being capable of being vertically connected to the second motherboard; and
a third edge, substantially parallel to the first edge, a back connector, located on the third edge being capable of plugging into the first motherboard in parallel.

9. The NIC of claim 8, wherein the network socket is a RJ45 socket.

10. The NIC of claim 8, wherein the back connector and the side connector are the same type.

11. The NIC of claim 8, wherein the back connector and the side connector are PCI connectors.
